(19) United States
(12) Patent Application Publication
(10) Pub. No.: US 2003/0009579 A1
(43) Pub. Date: Jan. 9, 2003

(54) Contents data transmission system

(75) Inventors: Jun Kawai, Kawasaki (JP); Toshihiro Sonoda, Kawasaki (JP); Tomoyoshi Takebayashi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/984,528

(22) Filed: Oct. 30, 2001

(30) Foreign Application Priority Data
Jul. 6, 2001 (JP) 2001-205810

(51) Int. Cl. G06F 15/16

(52) U.S. Cl. 709/231

(57) ABSTRACT

A contents data transmission system is provided, which can perform download of contents data such as music or pictures with high flexibility while avoiding interference with other communications. A contents server at a transmission side stores contents data divided into plural blocks along the time axis direction and includes a contents structure block list. When a user system at a reception side designates contents to be downloaded, the contents server transmits the contents structure block list to the user system. A user uses the user system for scheduling block download, and the user system transmits a request for download with block designation to the contents server in accordance with the schedule. The contents server transmits the designated blocks sequentially to the user system in accordance with the request.

### BACKGROUND OF THE INVENTION

1. Field of the Invention

The present invention relates to a system for transmitting (or downloading) sequential contents data such as music data or picture data via a communication path.

2. Description of the Prior Art

Conventionally, these types of contents data are usually downloaded sequentially from the top of data file. Furthermore, an available band of the communication path is used fully so as to complete the download as fast as possible. It is also common to start reproducing downloaded contents such as music or pictures while downloading the contents in addition to the case of starting reproduction after waiting the contents being downloaded completely.

However, the reproduction is understandably available only for a part that is already downloaded even if the music or the pictures are reproduced while downloading the data file. For example, if a user wants to reproduce from the middle portion of the contents, he or she has to wait until a part of the contents that is necessary for the reproduction is downloaded.

In addition, even if the download is not required to finish soon, it may use the communication path entirely and interfere with other communications. For example, if the downloaded contents are not required to be reproduced soon, the finish time of the download can be postponed to a designated time.

### SUMMARY OF THE INVENTION

An object of the present invention is to provide a contents data transmission system that can perform download of contents data such as music or pictures with high flexibility while avoiding interference with other communications.

The present invention provides a system for transmitting contents data via a communication path. A transmission side stores contents data divided into plural blocks along the time axis direction, changes transmission order of the plural blocks of the contents data dynamically responding to a request from a reception side and transmits the contents data to the reception side.

In this way, a part necessary for e.g., fast forward reproduction can be transmitted first so as to enable the fast forward reproduction.

In addition, a transmission interval between plural blocks can be changed dynamically. For example, if the transmission (download) does not need to hasten, the transmission interval between the plural blocks can be as long as possible so that other communications are not interfered.

As a concrete structure, the contents data transmission system comprises a contents structure block list that contains information about a block structure of the contents data and is used for changing the transmission order of the plural blocks dynamically, scheduling means for changing the transmission order of the plural blocks and contents restructuring means for restructuring the contents from the transmitted blocks.

In a preferred embodiment, the reception side structures the contents structure block list from the information about the blocks contained in the transmitted blocks while downloading the contents data. Namely, the contents structure block list is not prepared separately from the contents, but information for structuring the contents structure block list is described in the block contents. Thus, after starting the reception, the contents structure block list is structured from the information that is described in a block (e.g., in a header). Concerning data necessary for special reproduction too, information such as whether the data exist or not, a position of the data in a block, or a list of other blocks necessary for the special reproduction can be described in a block, and a data list necessary for the special reproduction can be structured from the information.

In another preferred embodiment, in order to perform the reproduction or the special reproduction responding to a request from the reception side, the system further comprises contents control means for extracting data necessary for reproduction or special reproduction while restructuring contents from the transmitted blocks. For example, concerning data beyond the position designated by a user, if restructure of data necessary for continuing the reproduction or the special reproduction is completed, the data are given to the contents reproduction means from the designated position so as to perform the reproduction or the special reproduction. The restructuring quantity of data necessary for continuing the reproduction is set to a value such that a buffer underflow does not occur after starting the reproduction, considering the transmission speed of the download and the downloaded reproduction data quantity (time) from the reproduction designation position to the current position in the transmission. In the case of the special reproduction, high speed performance can be realized by referring the information of the special reproduction data position structured from the contents structure block list and the information in a block.

In still another preferred embodiment, when the reception side instructs reproduction or special reproduction while downloading the contents data, the transmission order of the plural blocks is changed in such a manner that the blocks after the designated position of the reproduction or the special reproduction in the instruction are transmitted first.

In still another preferred embodiment, the contents structure block list contains information for recognizing a block containing data necessary for special reproduction, and when the reception side instructs reproduction or special reproduction while downloading the contents data, the transmission order of the plural blocks is changed in such a manner that the blocks containing data necessary for the special reproduction are transmitted first in accordance with information described in the contents structure block list.

In still another preferred embodiment, the contents structure block list or each of the blocks contains position information of data necessary for special reproduction, and the reception side extracts the data necessary for the special reproduction in accordance with the position information so as to perform the special reproduction at high speed. For example, in the case of MPEG2 format picture contents, position of i (Intra) frame data in the block is recorded as the position information of data necessary for special reproduction. The reception side extracts only the i-frame data from the position information in the block at high speed, decodes the i-frame data, and performs special reproduction such as fast forward, pause or frame-by-frame advance. In addition, if data for special reproduction are positioned in contents, similar process can be performed by recording the position of the data in the block.

In still another preferred embodiment, when the contents data are divided into plural blocks along the time axis direction, one of the blocks is made of only data necessary for special reproduction. For example, in the case of MPEG2 format picture contents, one of the blocks is made of the i-frame data. Alternatively, if data used only for fast forward reproduction are inserted between data for reproduction like a D-VHS picture record format, one of the blocks is made of the data for fast forward reproduction. At the reception side, special reproduction such as fast forward can be performed by reproducing only the block.

In still another preferred embodiment, when the contents data are divided into plural blocks along the time axis direction, data necessary for special reproduction are located in a specific position in each of the blocks. For example, in the case of MPEG2 format picture contents, the contents data are divided into blocks in such a way that i-frame data are located at the top of each block. The reception side can perform special reproduction such as fast forward by reproducing only data at the top portion of each block.

In still another preferred embodiment, contents data for special reproduction are prepared separately from contents data for reproduction at the transmission side, the contents data for the special reproduction are divided into plural blocks along the time axis direction in the same way as the contents data for the reproduction, and the transmission order of the plural blocks is changed in such a manner that blocks of the contents data for the special reproduction are added to blocks of the contents data for the reproduction and the blocks of the contents data for the special reproduction are transmitted first responding to a request for special reproduction from the reception side. This structure is suitable for the case where preview data are prepared separately from the contents, for example.

In still another preferred embodiment, when the reception side makes a request for download of plural sets of contents data, the transmission order of the plural blocks is changed concerning the whole of the plural sets of contents data. For example, in the case where every type of music is defined as independent contents and plural sets of music data are designated to be downloaded, download schedule is changed in such a manner that blocks of the reproduction position of the designated music are downloaded first even if the music of the reproduction designation has a download order later than the music under download.

In still another preferred embodiment, a time interval between block transmissions is adjustable responding to a request from the reception side. Especially, responding to download completion time or time period necessary for download designated at the reception side, and in accordance with a communication path usage situation, the transmission order of the blocks or the time interval between transmissions is adjusted. In this case, plural sets of contents can be designated for download, without being limited to one set of contents. It is checked first whether the interval between blocks to be downloaded can be increased or not considering remaining time till the desired time, a size of data to be downloaded (total size if plural contents are to be downloaded) and a communication path band. Second, the communication path usage situation of the current user is checked. If the communication path is used, the download is scheduled so that the usage band is not oppressed. On this occasion, it is desirable to do the scheduling by considering usage history of the communication path (difference of usage situation between dates and times, days of the week and time zones) so that influence to the current communication becomes as small as possible.

In still another preferred embodiment, the reception side transmits information about a communication band to be used to the transmission side, and the transmission side adjusts a block size in accordance with the informed communication band when dividing the contents data into plural blocks. Basically, the block size is adjusted to be small when using a slow communication path, while it is adjusted to be large when using a fast communication path. Thus, the transmission time and the transmission order can be adjusted by a short execution time of the reception side.

### BRIEF DESCRIPTION OF THE DRAWINGS

FIG. 1 is a sequence diagram of a contents data transmission system according to a first embodiment of the present invention.

FIG. 2 is a block diagram of the contents server of the contents data transmission system according to the first embodiment of the present invention.

FIG. 3 is a block diagram of a user system of the contents data transmission system according to the first embodiment of the present invention.

FIG. 4 is a sequence diagram of a contents data transmission system according to a second embodiment of the present invention.

FIG. 5 is a block diagram of the contents server of the contents data transmission system according to the second embodiment of the present invention.

FIG. 6 is a block diagram of a user system of the contents data transmission system according to the second embodiment of the present invention.

FIGS. 7A and 7B show examples of dividing contents data into blocks.

FIG. 8 shows some examples of changing transmission order of block contents data.

### DESCRIPTION OF THE PREFERRED EMBODIMENTS

Hereinafter, the present invention will be explained more in detail with reference to embodiments and drawings.

A contents data transmission system according to the present invention can be embodied in two types. In one type, transmission block control is performed at a reception side, while in the other type, it is performed at a transmission side. The former will be explained as a first embodiment, and the latter will be explained as a second embodiment.

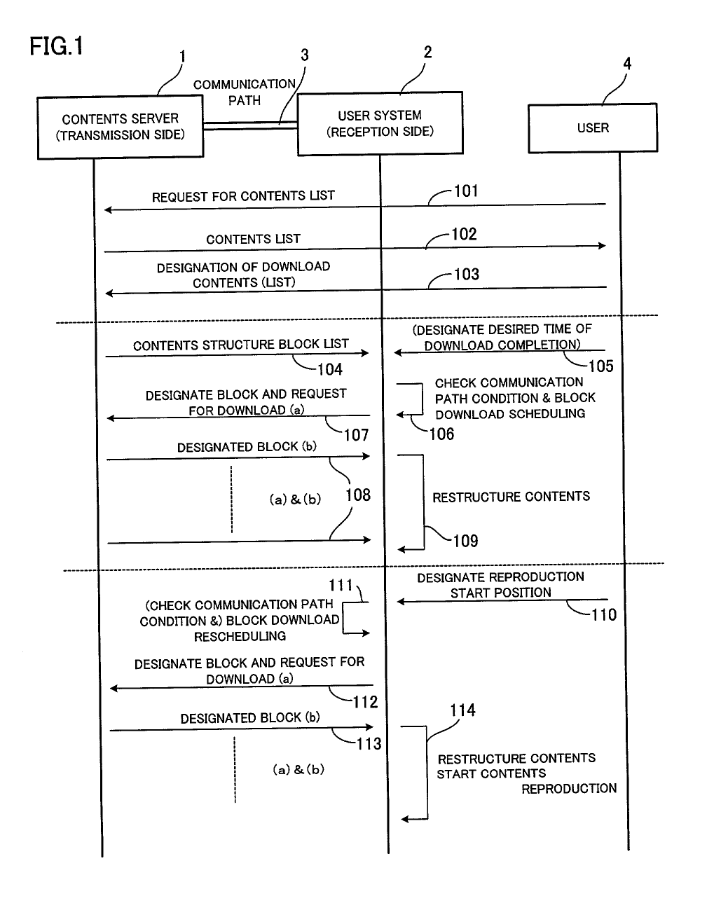

FIG. 1 is a sequence diagram of a contents data transmission system according to the first embodiment of the present invention. As shown in FIG. 1, a contents server 1 at the transmission side and a user system 2 at the reception side are connected with a communication path 3. A user 4 can download contents (data) from the contents server 1 by using the user system 2 so as to reproduce music or pictures. In the following explanation, numerals in parentheses correspond to reference numerals in FIG. 1 as well as in other figures.

In FIG. 1, the user makes a request to the contents server 1 for a contents list first, using the user system 2 (101). Responding to this request, the contents server 1 transmits the contents list to the user system 2 (i.e., the user 4) (102). The user 4 uses the user system 2 for transmitting a designation (a list) of contents to be downloaded to the contents server 1 (103).

The contents server 1 has divided the contents into plural blocks and prepared a contents structure block list. Then, responding to the designation of the download contents from the user 4 (103), the contents server 1 transmits the contents structure block list of the contents to the user system 2 (104).

The user 4 may designate desired time of the download completion and transmits the desired time to the user system 2 (105), if it does not need to reproduce the data soon after being downloaded but needs to finish the download by the designated time. Then, in accordance with a condition designated by the user 4 at the reception side, the user system 2 checks a communication path condition and performs block download scheduling (106). In accordance with the scheduling, the user system 2 transmits a request for download to the contents server 1 while designating blocks (107), and the contents server 1 transmits the designated blocks to the user system 2 sequentially according to the request (108). The user system 2 restructures the contents from the received blocks (109).

If the user 4 transmits designation of a reproduction start position to the user system 2 (110), the user system 2 performs rescheduling of the block download (111). On this occasion, the communication path condition is checked again if necessary. In accordance with the rescheduling result, the user system 2 transmits a request for download to the contents server 1 while designating blocks (112). The contents server 1 transmits the designated blocks sequentially (113), and the user system 2 starts reproduction from the designated position while restructuring the contents from the received blocks (114).

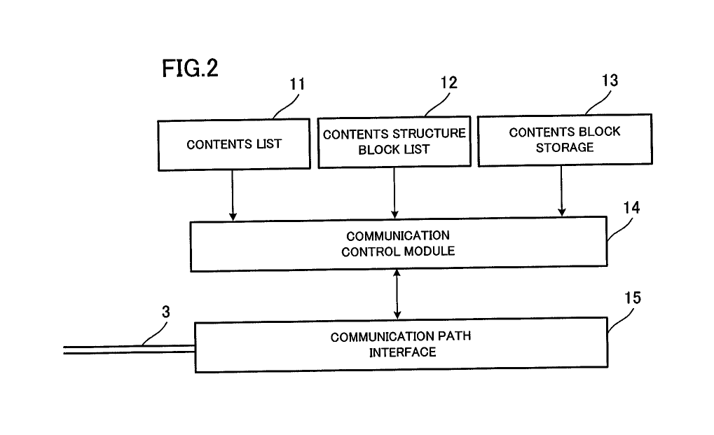

FIG. 2 is a block diagram of the contents server 1 of the contents data transmission system according to the first embodiment of the present invention. The contents server 1 comprises a contents list 11 and a contents structure block list 12 as mentioned above. In addition, the contents server 1 comprises a contents block storage 13 for storing contents of each contents block, a communication control module 14 and a communication path interface 15. The communication path interface 15 is connected to the communication path 3. In this embodiment, the contents server 1 has a simple structure since the control of the transmission block is performed at the reception side as mentioned above.

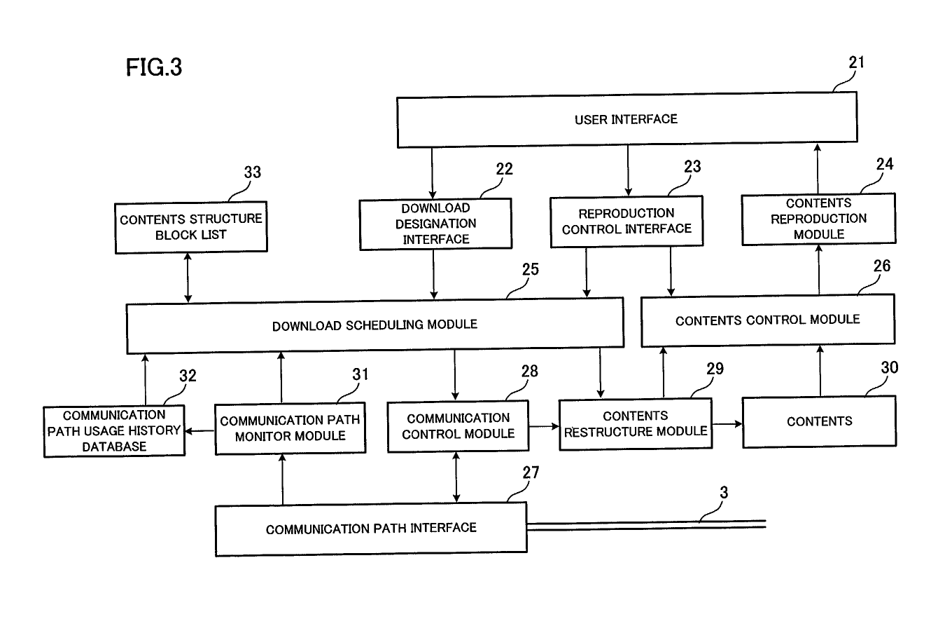

FIG. 3 is a block diagram of the user system 2 of the contents data transmission system according to the first embodiment of the present invention. Instructions are given to a download designation interface 22 and a reproduction control interface 23 from a user interface 21 that works as an interface with the user 4 using a display screen or a keyboard, while contents reproduced by a contents reproduction module 24 are given to the user interface 21. The download designation interface 22 and the reproduction control interface 23 give signals to a download scheduling module 25. Moreover, the reproduction control interface 23 gives a signal to a contents control module 26, too.

Contents 30 are restructured by a contents restructure module 29 after passing through a communication path interface 27 connected to the communication path 3 and a communication control module 28 and are given to the contents control module 26 and to the user interface 21 via a contents reproduction module 24.

In addition, situation of the communication path 3 is monitored by a communication path monitor module 31 via the communication path interface 27, and the monitor result is reported to the download scheduling module 25. The monitor result is also imparted to a communication path usage history database 32, and data read out of the communication path usage history database 32 are given to the download scheduling module 25.

At a contents structure block list 33 whose data are transmitted to and received from the download scheduling module 25, the block list downloaded from the contents server 1 is usually stored. However, it is possible that the user system 2 produces the contents structure block list from information about blocks that was downloaded from the contents server 1.

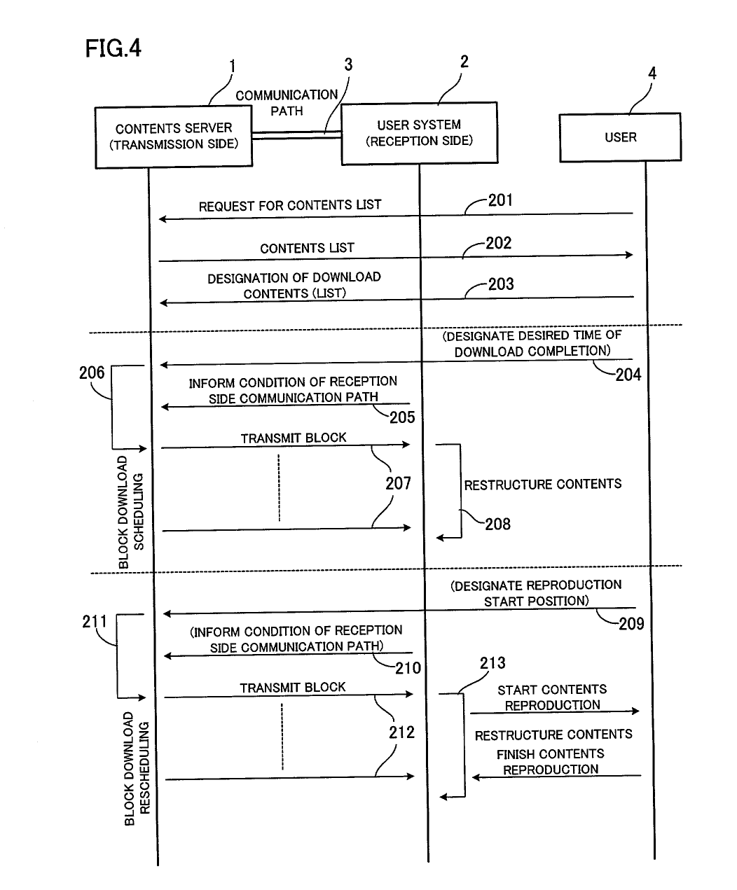

FIG. 4 is a sequence diagram of the contents data transmission system according to a second embodiment of the present invention. In this embodiment, the transmission block control is performed at the transmission side.

The user 4 transmits a request for a contents list to the contents server 1 using the user system 2 (201). Responding to this request, the contents server 1 transmits the contents list to the user system 2 (i.e., the user 4) (202). The user 4 uses the user system 2 for transmitting designation (a list) of contents to be downloaded to the contents server 1 (203). In addition, desired time of the download completion designated by the user 4 if necessary is transmitted to the contents server 1 (204). Furthermore, the user system 2 informs the contents server 1 of a condition of the reception side communication path (205).

The contents server 1 has divided the contents into plural blocks and stored them. Responding to designation of the download contents (203) and designation of desired time of the download completion from the user 4, the contents server 1 performs scheduling of the block download of the contents (206). On this occasion, the condition of the reception side communication path that was informed by the user system 2 is considered. The contents server 1 transmits the blocks sequentially in accordance with the produced schedule (207). The user system 2 restructures the contents from the received blocks (208).

If the user 4 designates a reproduction start position, the designation is transmitted to the contents server 1 (209). Furthermore, the condition of the reception side communication path is transmitted to the contents server 1 again if necessary (210). The contents server 1 performs rescheduling of the block download (211) and transmits the blocks sequentially in accordance with the schedule (212). The user system 2 starts reproduction from the designated position while restructuring the contents from the received blocks (213).

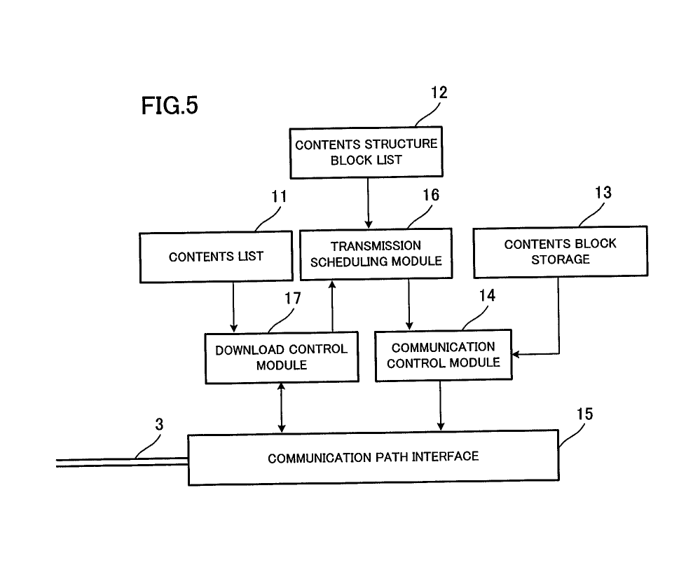

FIG. 5 is a block diagram of the contents server 1 of the contents data transmission system according to the second embodiment of the present invention. The contents server 1 comprises the contents list 11 and the contents structure block list 12 as mentioned above. In addition, the contents block storage 13 for storing contents of each contents block, the communication control module 14 and the communication path interface 15 are provided to the contents server 1. The communication path interface 15 is connected to the communication path 3. In this embodiment, a transmission scheduling module 16 and a download control module 17 are provided to the contents server 1 so that the transmission block control is performed at the transmission side.

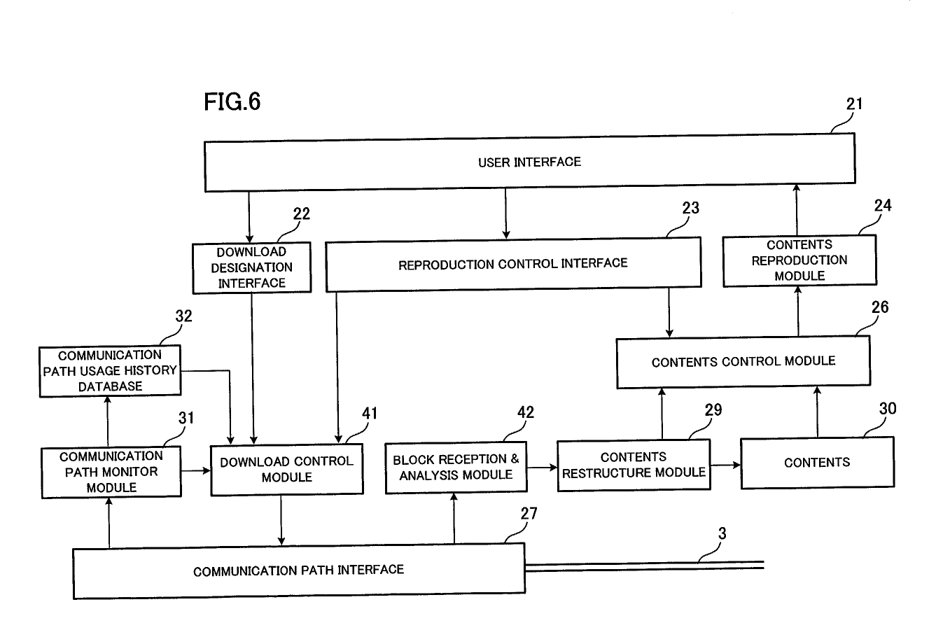

FIG. 6 is a block diagram of the user system 2 of the contents data transmission system according to the second embodiment of the present invention. Instructions are given to a download designation interface 22 and a reproduction control interface 23 from a user interface 21 that works as an interface with the user 4 using a display screen or a keyboard, while reproduced contents reproduced in the contents reproduction module are given to the user interface 21. The download designation interface 22 and the reproduction control interface 23 give signals to the download control module 41. Furthermore, the reproduction control interface 23 gives a signal to the contents control module 26.

Contents 30 are restructured by a contents restructure module 29 after passing through a communication path interface 27 connected to the communication path 3 and a block reception & analysis module 42 and are given to the contents control module 26 and to the user interface 21 via a contents reproduction module 24.

In addition, situation of the communication path 3 is monitored by a communication path monitor module 31 via the communication path interface 27, and the monitor result is reported to the download control module 41. The monitor result is also imparted to the communication path usage history database 32, and data read out of the communication path usage history database 32 are given to the download control module 41.

In this embodiment, since the transmission block control is performed at the transmission side, the user system 2 does not need the contents structure block list or the download scheduling module. The user system 2 transmits information about the reproduction position and the reproduction method (normal reproduction or special reproduction such as fast forward) to the contents server 1, and the contents server 1 determines the transmission start block in accordance with the information.

A label (such as a block position in the contents contained in the header, a contents size, a block number, and information about data for special reproduction) that is necessary for restructuring the contents and a position tag indicating which part of data is the (special) reproduction position designated by the user system 2 are added to the block. The user system 2 restructures the contents in accordance with the label and the tag so as to perform the reproduction. After the block transmission starts, the user system 2 simply performs reception waiting, so the communication control becomes easy. Moreover, it is possible to use a uni-directional communication path such as radio frequency broadcasting as a communication path for the transmission.

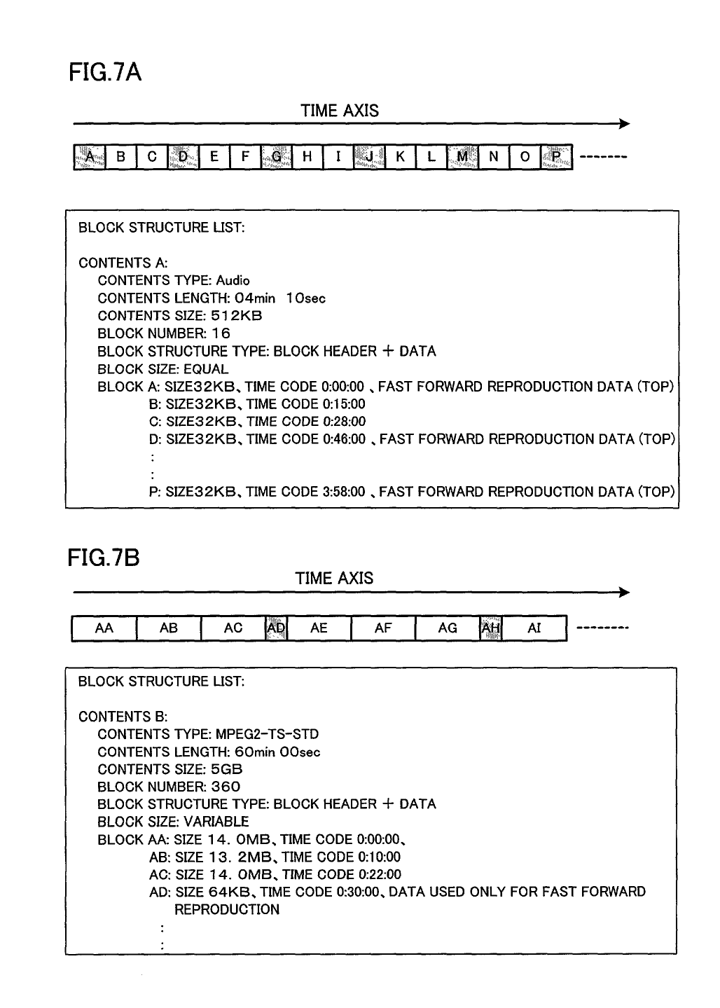

FIGS. 7A and 7B show examples of dividing contents data into blocks. FIG. 7A is an example of music contents divided into blocks equally along the time axis direction, in which fast forward reproduction data are inserted at every plural blocks as shown by blocks A, D, G, J, M, P, . . . FIG. 7B is an example of picture contents divided into blocks unequally along the time axis direction, in which fast forward reproduction data are inserted at every plural blocks as shown by blocks AD, AH, . . . .

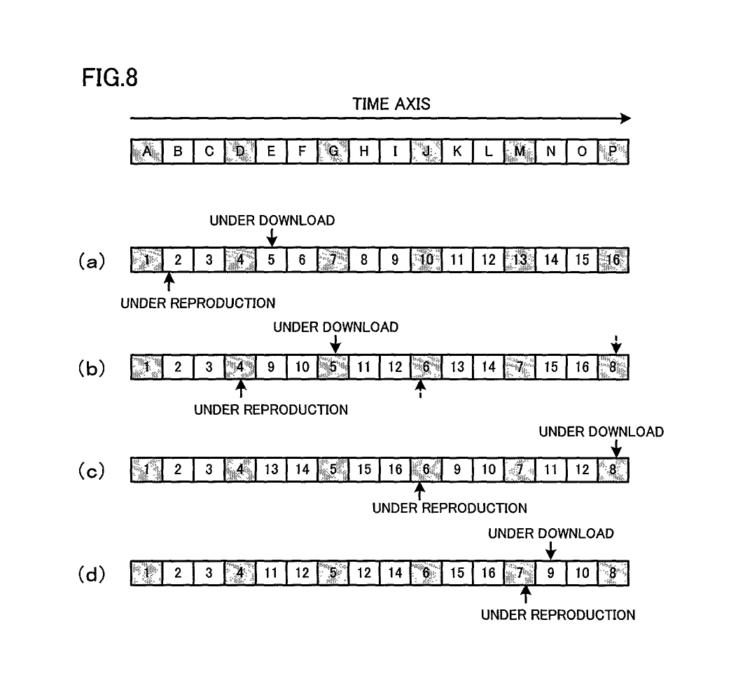

FIG. 8 shows some examples of changing transmission order of block contents data. The contents are divided into plural blocks along the time axis direction as denoted by A, B, C, . . . . Moreover, data blocks that can be used for special reproduction such as fast forward are positioned at every plural blocks as denoted by A, D, G, . . . In each example (a) through (d) of changing the transmission order, numeral in each block denotes the transmission order. A downward arrow positioned at the upper side of a block indicates a current position during download, while an upward arrow positioned at the lower side of a block indicates a current position during reproduction (or special reproduction).

As shown in (a) of FIG. 8, download (transmission) is normally performed from the first block A. In this example, the block E is under download and the block B is under reproduction. In this state, if fast forward reproduction is instructed for example, transmission order of the blocks is changed as shown in (b).

Namely, the transmission of the block E is interrupted, and the blocks G, J, M and P that are necessary for the fast forward reproduction are transmitted first. After that, other blocks including the interrupted block E are transmitted sequentially. When the transmission of the block E is interrupted, the interrupt position in the block E is memorized, so that the transmission of the block E can be restarted from the memorized position. Of course, it is possible to restart the transmission of the block E from the beginning if the contents requires.

The example of (c) in FIG. 8 shows the case where the transmission order is changed when normal reproduction from some midpoint is instructed during fast forward reproduction. Namely, in the example of (b), it is supposed that the current position during fast forward reproduction moves from the block D (an arrow of full line) to the block 3 (an arrow of broken line), and the current position during download moves from the block G (an arrow of full line) to the block P (an arrow of broken line). On this occasion, if normal reproduction is instructed, the normal reproduction starts from the block J under fast forward reproduction as shown in (c), and the block K and the following blocks out of remaining blocks are transmitted first. After finishing the transmission of the last block O, the transmission of the block E restarts.

The example of (d) in FIG. 8 shows the case where the transmission order is changed when reproduction position is moved forward during sequential reproduction from the top. For example, in the state shown in (b), it is supposed that the reproduction position is moved to the block M. Then, as shown in (d), reproduction starts from the block M, and the block N and the following blocks out of the remaining blocks are transmitted first. After finishing the transmission of the last block 0, the transmission of the block E restarts.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A system for transmitting contents data via a communication path, wherein a transmission side stores contents data divided into plural blocks along the time axis direction, changes transmission order of the plural blocks of the contents data dynamically responding to a request from a reception side and transmits the contents data to the reception side.

2. The system according to claim 1, comprising a contents structure block list that contains information about a block structure of the contents data and is used for changing the transmission order of the plural blocks dynamically, scheduling means for changing the transmission order of the plural blocks and contents restructuring means for restructuring the contents from the transmitted blocks.

3. The system according to claim 1, wherein the reception side structures the contents structure block list from the information about the blocks contained in the transmitted blocks while downloading the contents data.

4. The system according to claim 2, further comprising contents control means for extracting data necessary for reproduction or special reproduction while restructuring contents from the transmitted blocks so as to perform the reproduction or the special reproduction responding to a request from the reception side.

5. The system according to claim 1, wherein when the reception side instructs reproduction or special reproduction while downloading the contents data, the transmission order of the plural blocks is changed in such a manner that the blocks after the designated position of the reproduction or the special reproduction in the instruction are transmitted first.

6. The system according to claim 1, wherein the contents structure block list contains information for recognizing a block containing data necessary for special reproduction, and when the reception side instructs reproduction or special reproduction while downloading the contents data, the transmission order of the plural blocks is changed in such a manner that the blocks containing data necessary for the special reproduction are transmitted first in accordance with information described in the contents structure block list.

7. The system according to claim 1, wherein the contents structure block list or each of the blocks contains position information of data necessary for special reproduction, and the reception side extracts the data necessary for the special reproduction in accordance with the position information so as to perform the special reproduction at high speed.

8. The system according to claim 1, wherein when the contents data are divided into plural blocks along the time axis direction, one of the blocks is made of only data necessary for special reproduction.

9. The system according to claim 1, wherein when the contents data are divided into plural blocks along the time axis direction, data necessary for special reproduction are located in a specific position in each of the blocks.

10. The system according to claim 1, wherein contents data for special reproduction are prepared separately from contents data for reproduction at the transmission side, the contents data for the special reproduction are divided into plural blocks along the time axis direction in the same way as the contents data for the reproduction, and the transmission order of the plural blocks is changed in such a manner that blocks of the contents data for the special reproduction are added to blocks of the contents data for the reproduction and the blocks of the contents data for the special reproduction are transmitted first responding to a request for special reproduction from the reception side.

11. The system according to claim 1, wherein when the reception side makes a request for download of plural sets of contents data, the transmission order of the plural blocks is changed concerning the whole of the plural sets of contents data.

12. The system according to claim 1, wherein a time interval between block transmissions is adjustable responding to a request from the reception side.

13. The system according to claim 1, wherein transmission order or a time interval between block transmissions is adjusted in accordance with download completion time or time period necessary for the download designated at the reception side, and in accordance with usage situation of the communication path.

14. The system according to claim 1, wherein the reception side transmits information about a communication band to be used to the transmission side, and the transmission side adjusts a block size in accordance with the informed communication band when dividing the contents data into plural blocks.
